(19) United States
(12) Patent Application Publication
(10) Pub. No.: US 2023/0064055 A1
(43) Pub. Date: Mar. 2, 2023

(54) SYSTEMS AND METHODS FOR INCENTIVIZING PHYSICAL ACTIVITY

(71) Applicant: Wells Fargo Bank, N.A., San Francisco, CA (US)

(72) Inventor: Jonathan K. WAN, Oakland, CA (US)

(21) Appl. No.: 16/268,051

(22) Filed: Feb. 5, 2019

Related U.S. Application Data
(60) Provisional application No. 62/643,604, filed on Mar. 15, 2018.

(51) Int. Cl. G09B 19/00; G06Q 40/02; G06N 20/00

(52) U.S. Cl. CPC G09B 19/00; G06Q 40/02; G06N 20/00

(57) ABSTRACT

Systems, apparatuses, methods, and computer program products are disclosed for incentivizing physical activity based on a combination of wellness information and financial information. An example method includes retrieving a first set of wellness information regarding the user and retrieving a set of financial information regarding the user. The example method further includes deriving a second set of wellness information regarding the user from the set of financial information regarding the user. The example method further includes calculating a number of sweat points corresponding to the first set of wellness information and the second set of wellness information and updating a total number of sweat points contained in a sweat point account associated with the user. In some embodiments, the example method further includes causing transmission of a targeted message to the user based on information about the user.

### CROSS-REFERENCE TO RELATED APPLICATIONS

This application claims priority to U.S. Provisional Application No. 62/643,604 filed Mar. 15, 2018, the content of which is incorporated herein by reference in its entirety.

### TECHNOLOGICAL FIELD

Example embodiments of the present disclosure relate generally to use of external stimuli to incentivize user behavior and, more particularly, to systems and methods for incentivizing physical activity of a user based on wellness information and financial information regarding the user.

### BACKGROUND

Humans are impulsive actors. Despite often intending to achieve long-term goals, human nature often nudges everyday behavior towards activities that run counter to such long term goals. For instance, it is common for people to make long term goals, but uncommon for people to sustain the modified behavior patterns needed to achieve them. Accordingly, there is an ever-present need for ways to modify a user's set of incentives for short- and medium-term decision-making in a manner that aligns the user's actions with his or her long-term goals.

### BRIEF SUMMARY

One specific way in which natural human behavior detracts from long-term planning relates to physical activity. It is common to for people to set goals relating to physical activity. For instance, people routinely set New Year's resolutions to reach exercise milestones or lose weight. Nevertheless, people typically fail to sustain the exercise or diet regimens needed to achieve their desired goals. Statistics regarding obesity and the general deterioration of physical health in developed countries such as the United States illustrate the urgent need for new systems that can counteract the bad influences of human nature on short- and medium-term decision-making and improve the chances that people can achieve their long-term goals related to physical health.

New technology has introduced new tools for solving this problem. As technology has advanced, so has the ability to more closely monitor of human activity. Recent proliferation of wearable devices has facilitated automated cataloging of user wellness information, new apps have been developed that facilitate sophisticated tracking of this wellness information, and increasingly sophisticated user interfaces have been developed that further facilitate the manual entry of wellness information that is not currently amenable to automated tracking. However, wellness information has historically been utilized in a siloed ecosystem, such that it is generated for purely wellness-related uses, and such that the wellness goals are evaluated on the basis of only directly gathered wellness information. By segregating wellness information from other types of user information gathered in today's digital economy, historical systems fail to maximize the completeness and accuracy of wellness information tracking, and also fail to maximize the impact of the wellness information that is gathered. In particular, financial information associated with a user can shed significant light on the wellness-related activities of a user that may otherwise be untraceable by traditional modes of wellness information collection. For instance, when a user does not utilize a wearable device and has a poor track record of manually recording wellness information, financial information can nevertheless indicate when the user is likely engaging in physical activity. Unfortunately, financial information associated with a user is often unavailable to the traditional entities involved in wellness tracking.

Accordingly, a need exists for new systems, apparatuses, methods, and computer program products that facilitate the use of financial information in combination with wellness information to increase the sophistication of wellness monitoring and tracking and to increase the ability to incentivize physical activity in ways that better align a user's short- and medium-term decision-making with the user's long term physical health goals.

Example embodiments described herein provide a solution to this need and others by disclosing systems, apparatuses, and methods using which a financial institution can deploy a wellness program that leverages both the wellness information that can be collected by the new technologies described above in combination with the financial information available only to financial institutions themselves. By doing so, example embodiments described herein enable a financial institution to generate a more complete and accurate representation of a user's wellness status that in turn can enable users to identify areas both in their physical activity and financial activity that could be better aligned to meet their wellness goals. Through the combination of wellness information and financial information, example embodiments further facilitate a broader array of uses for the combined set of wellness and financial information, such as the ability to provide improved targeting of advertisements or more closely tailored healthcare offerings. Finally, by providing new functionality and modes of user engagement that diverge from traditional offerings of financial institutions or wellness-focused entities, example embodiments described herein enable financial institutions to drive deeper and more meaningful relationships with existing customers and provide a new vehicle for securing new customer relationships.

In a first example embodiment, a computer-implemented method is provided for incentivizing physical activity based on a combination of wellness information and financial information. The method includes retrieving, by data aggregation circuitry, a first set of wellness information regarding the user, and retrieving, by the data aggregation circuitry, a set of financial information regarding the user. The method further includes deriving, by the data aggregation circuitry, a second set of wellness information regarding the user from the set of financial information regarding the user. The method further includes calculating, by a rule-based system, a number of sweat points corresponding to the first set of wellness information and the second set of wellness information, and incrementing a value stored in a database field by the calculated number of sweat points, the value stored in the database field defining a total number of sweat points contained in a sweat point account associated with the user. The method may further include causing, by targeting circuitry, transmission of a targeted message to the user based on at least one of (i) the value stored in the database field, (ii) the first set of wellness information, (iii) the second set of wellness information, or (iv) the set of financial information.

In some embodiments, transmission of the targeted message to the user is based on two or more of (i) the value stored in the database field, (ii) the first set of wellness information, (iii) the second set of wellness information, or (iv) the set of financial information.

In some embodiments, retrieving the first set of wellness information regarding the user comprises transmitting, by communications circuitry, an electronic control signal requesting the first set of wellness information from a wearable device associated with the user and, in response to transmitting the electronic control signal, receiving the first set of wellness information from the wearable device.

In some embodiments, retrieving the first set of wellness information regarding the user comprises generating, by the data aggregation circuitry, an application programming interface (API) call structured to request the first set of wellness information from a third party application hosted by a user device or a partner device, transmitting, by communications circuitry, the application programming interface (API) call to the user device or the partner device and, in response to transmitting the API call, receiving the first set of wellness information from the user device or the partner device.

In some embodiments, the set of financial information regarding the user is retrieved by the data aggregation circuitry from a memory.

In some embodiments, deriving the second set of wellness information regarding the user from the set of financial information regarding the user comprises parsing, by the data aggregation circuitry, the set of financial information to identify a subset of financial information indicative of physical activity, and identifying, by the data aggregation circuitry, wellness information corresponding to each element of the subset of financial information, wherein the second set of wellness information comprises the identified wellness information. In some such embodiments, the set of financial information comprises transaction data from one or more credit or debit accounts associated with the user, and the subset of financial information indicative of physical activity comprises one or more transactions associated with merchants from a predefined set of merchants that are identified as providing products or services related to wellness.

In some embodiments, the computer-implemented method further includes generating, by artificial intelligence (AI) circuitry, a financial health recommendation for the user based on the first set of wellness information and the set of financial information, wherein the targeted message comprises the financial health recommendation. In some such embodiments, generating the financial health recommendation for the user comprises providing the first set of wellness information and the set of financial information as inputs into a machine learning model and, in response to providing the wellness information and the set of financial information, receiving the financial health recommendation for the user from the machine learning model.

In some embodiments, the computer-implemented method includes generating, by AI circuitry, a wellness recommendation for the user based on the first set of wellness information and the second set of wellness information, wherein the targeted message comprises the wellness recommendation. In some such embodiments, the AI circuitry comprises a machine learning model, and generating the wellness recommendation comprises providing the first set of wellness information and the second set of wellness information as inputs into the machine learning model and, in response to providing the first set of wellness information and the second set of wellness information to the machine learning model, receiving the wellness recommendation for the user from the machine learning model.

In some embodiments, calculating the number of sweat points that corresponds to the first set of wellness information and the second set of wellness information includes providing the first set of wellness information and the second set of wellness information as inputs into the rule-based system, and calculating, by the rule-based system and based on a set of rules governing the rule-based system and having predefined point allocations for predefined activities, a number of points corresponding to the first set of wellness information and the second set of wellness information. In some such embodiments, the computer-implemented method includes modifying, by AI circuitry and based on the first set of wellness information or the second set of wellness information, the set of rules. Additionally or alternatively, other such embodiments of the computer-implemented method include modifying, by AI circuitry and based on the first set of wellness information and the second set of wellness information, a set of weights associated with the set of rules.

In some embodiments, causing transmission of the targeted message to the user comprises transmitting, by communications circuitry and to a merchant partner device, user information comprising one or more of (i) the first set of wellness information, (ii) the second set of wellness information, (iii) the set of financial information, and (iv) the total number of sweat points contained in the sweat point account associated with the user, and receiving, by the communications circuitry and from the merchant partner device, a promotion comprising an advertisement for a product or service, wherein the targeted message comprises the promotion.

In some embodiments, causing transmission of the targeted message to the user comprises transmitting, by communications circuitry and to a healthcare partner device, user information comprising one or more of (i) the first set of wellness information, (ii) the second set of wellness information, (iii) the set of financial information, and (iv) the total number of sweat points contained in the sweat point account associated with the user, and receiving, by the communications circuitry and from the healthcare partner device, information describing a personalized health plan from the healthcare partner device, the personalized health plan comprising a health plan having personalized characteristics, wherein the targeted message comprises the information describing the personalized health plan.

In some embodiments, the computer-implemented method further comprises generating, by targeting circuitry and based on one or more of (i) the first set of wellness information, (ii) the second set of wellness information, (iii) the set of financial information, and (iv) the total number of sweat points contained in the sweat point account associated with the user, a financial product recommendation, the financial product recommendation including an offer relating to a financial product or service that may be accepted in exchange for a particular number of sweat points, wherein the targeted message comprises the financial product recommendation.

In some embodiments, the computer-implemented method further includes receiving, by the input-output circuitry, a response to the targeted message, and causing implementation of an action based on the response.

In another example embodiment, an apparatus for incentivizing physical activity based on a combination of wellness information and financial information, the apparatus comprising the circuitry components configured to perform the steps recited in connection with the example computer-implemented method above.

In yet another example embodiment, a computer program product is provided for incentivizing physical activity based on a combination of wellness information and financial information. The computer program product comprising at least one non-transitory computer-readable medium storing computer-executable instructions that, when executed, cause an apparatus to perform the steps recited in connection with the example computer-implemented method above.

The foregoing brief summary is provided merely for purposes of summarizing some example embodiments illustrating some aspects of the present disclosure. Accordingly, it will be appreciated that the above-described embodiments are merely examples and should not be construed to narrow the scope of the present disclosure in any way. It will be appreciated that the scope of the present disclosure encompasses many potential embodiments in addition to those summarized herein, some of which will be described in further detail below.

### BRIEF DESCRIPTION OF THE FIGURES

Having described certain example embodiments of the present disclosure in general terms above, reference will now be made to the accompanying drawings. The components illustrated in the figures may or may not be present in certain embodiments described herein. Accordingly, some embodiments may include fewer or more components than those shown in the figures.

FIG. 1 illustrates an example environment within which some example embodiments may operate.

FIGS. 2 and 3 illustrate schematic block diagrams of example circuitry that may perform various operations in accordance with some example embodiments described herein.

FIG. 4 illustrates an example user interface for managing “sweat points” associated with a user's financial institution, in accordance with some example embodiments described herein.

FIG. 5 illustrates an example user interface for displaying targeted messages to a user, in accordance with some example embodiments described herein.

FIGS. 6A and 6B illustrate examples of user interfaces of third party applications using API integrations to provide information regarding sweat points associated with a user's financial institution, in accordance with some example embodiments described herein.

FIG. 7 illustrates an example user interface provided by a financial institution for personalized health plan selection based on both wellness and financial information, in accordance with some example embodiments described herein.

FIG. 8 illustrates an example flowchart for incentivizing physical activity, in accordance with some example embodiments described herein.

### DETAILED DESCRIPTION

Some embodiments of the present disclosure will now be described more fully hereinafter with reference to the accompanying figures, in which some, but not all embodiments of the disclosures are shown. Indeed, these disclosures may be embodied in many different forms and should not be construed as limited to the embodiments set forth herein; rather, these embodiments are provided so that this disclosure will satisfy applicable legal requirements. Like numbers refer to like elements throughout.

### Definitions

As used herein, the terms “data,” “content,” “information,” “electronic information,” “signal,” “command,” and similar terms may be used interchangeably to refer to data capable of being transmitted, received, and/or stored in accordance with embodiments of the present disclosure. Thus, use of any such terms should not be taken to limit the scope of embodiments of the present disclosure. Further, where a first computing device is described herein as receiving data from a second computing device, it will be appreciated that the data may be received directly from the second computing device or may be received indirectly via one or more intermediary computing devices, such as, for example, one or more servers, relays, routers, network access points, base stations, hosts, and/or the like, sometimes referred to herein as a “network.” Similarly, where a first computing device is described herein as sending data to a second computing device, it will be appreciated that the data may be sent directly to the second computing device or may be sent indirectly via one or more intermediary computing devices, such as, for example, one or more servers, relays, routers, network access points, base stations, hosts, and/or the like.

The term “comprising” means including but not limited to, and should be interpreted in the manner it is typically used in the patent context. Use of broader terms such as comprises, includes, and having should be understood to provide support for narrower terms such as consisting of, consisting essentially of, and comprised substantially of.

Where the specification states that a particular component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such terminology is intended to convey that the particular component or feature is included in some embodiments while excluded in others, or has the characteristic in some embodiments while lacking the characteristic in others.

The term “computing device” is used herein to refer to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” is used to refer to any computing device capable of functioning as a server, such as a master exchange server, web server, mail server, document server, or any other type of server. A server may be a dedicated computing device or a server module (e.g., an application) an application hosted by a computing device that causes the computing device to operate as a server.

The term “wellness information” refers to information related to the physical activity or health of an individual. Information related to the physical activity of a user may be specific data regarding physical exertion. For example, this may comprise exercise data describing the distance, time, speed, duration, intermittency or other characteristic of a workout. As another example, this may comprise specific sleep data relating to duration of sleep, stages of sleep, and the like. Information relating to physical activity of a user may also comprise general data regarding physical health. For example, this general data may comprise an individual's gender, age, height, weight, body mass index (BMI), body fat percentage, blood pressure, cholesterol, and the like. As another example, this general data may comprise information regarding an individual's smoking history, gym membership status, frequency of gym attendance, alcohol intake, family medical history, or the like. In some embodiments, wellness information includes biometric data (e.g., measurable biological characteristics) of a user. However, in other embodiments, wellness information does not include biometric data. In some embodiments, wellness information includes biometric data that cannot be uniquely associated with an individual and excludes biometric data that can be uniquely associated with a particular person. In some embodiments, wellness information refers to all information regarding the physical activity or health of an individual that cannot be classified as personally identifiable information (PII) as that term is used in information security and privacy laws.

The term “financial information” refers to any data relating to financial activity. Some examples of financial information comprise financial account information such as account numbers, account balances, transaction histories, or the like, credit information such as credit ratings, credit report information, and the like, or more detailed financial transaction information, including, for example, information that may be tracked for financial accounting purposes in line with Generally Accepted Accounting Principles (GAAP) or International Financial Reporting Standards (IFRS).

The term “financial product” refers broadly to a monetary contract between two or more parties, such as between an individual and a financial institution. A financial product may sometimes be referred to as an “instrument.” Some examples of financial products are cash instruments such as securities, loans, deposits, and the like whose value is determined by financial markets, and derivative transactions whose value is not determined directly by the financial markets.

The term “financial service” refers to the economic services provided within the financial industry. Some examples of financial services comprise commercial banking services, investment banking services, foreign exchange services, investment management services, insurance services, payment services, and the like.

The term “sweat point” refers to a financial product recognized by a financial institution as having a corresponding exchange value. For example, a single sweat point may be exchangeable by a financial institution for 2 cents. However, the exchange value is not necessarily currency. For example, 100 sweat points may be exchangeable for a discount on a financial product, but might not be exchangeable for cash. As described below, sweat points may be allocated to a user's sweat point account by a data management system in response to the provision, to the data management system, of wellness information and financial information regarding the user. In some embodiments, sweat points may be exchanged only within an ecosystem provided by the financial institution that operates the data management system 102. For instance, sweat points may be exchanged for products or services in-kind over a web portal provided by the financial institution, but might not be exchangeable directly via a web portal provided by the merchant who provides those products or services.

The term “sweat point account” refers to a logical representation of a number of sweat points allocated to a corresponding user. A total number of sweat points contained in a user's sweat point account may be defined by the value of a database field associated with a user and hosted in a database 106 of a data management system 102.

Having set forth a series of definitions called-upon throughout this application, an example system architecture is described below for implementing example embodiments and features of the present disclosure.

### System Architecture

Methods, systems, apparatuses, and computer program products of the present disclosure may be embodied by any of a variety of devices. For example, the method, system, apparatus, and computer program product of example embodiments may be embodied by one or more data management systems, user devices, and/or partner devices.

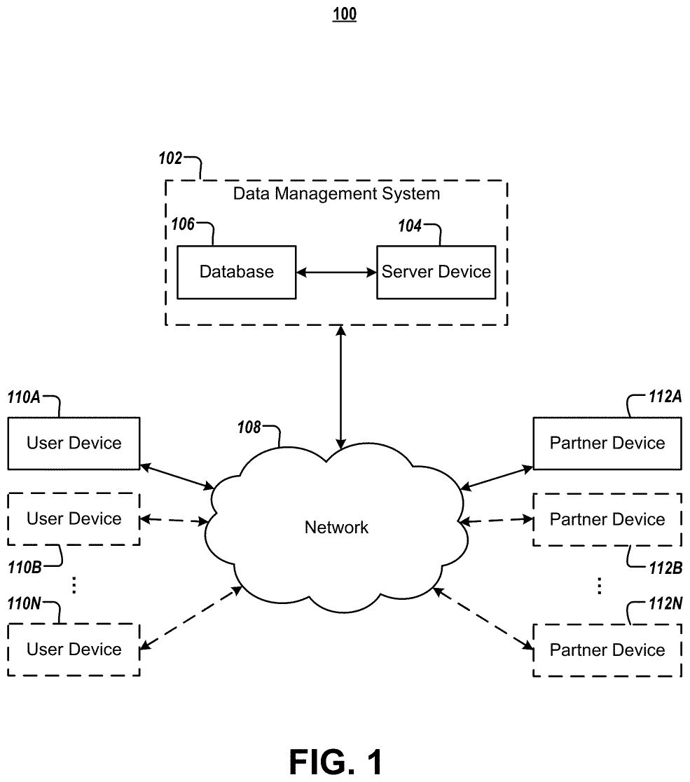

FIG. 1 illustrates an example system architecture 100 within which embodiments of the present disclosure may operate to incentivize physical activity of users. As illustrated, a data management system 102 may include one or more server devices 104 in communication with one or more databases 106. The data management system 102 may be embodied as one or more computers or computing systems as known in the art. The one or more server devices 104 may be embodied as one or more servers, remote servers, cloud-based servers (e.g., cloud utilities), processors, or any other suitable server devices, or any combination thereof. The one or more server devices 104 may receive, process, generate, and transmit data, signals, and electronic information to facilitate the operations of the data management system 102. The one or more databases 106 may be embodied as one or more data storage devices, such as a Network Attached Storage (NAS) device or devices, or as one or more separate databases or servers. The one or more databases 106 may store information accessed by the data management system 102 to facilitate the operations of the data management system 102. For example, the one or more databases 106 may store control signals, device characteristics, and access credentials of each user device 110A-110N and/or partner device 112A-112N, and may store user account credentials for one or more individuals who may utilize one or more of the user devices 110A-110N.

The data management system 102 may be connected to a network 108 (e.g., the Internet, or the like), using which the data management system 102 may communicate with one or more user devices 110A-110N and one or more partner devices 112A-112N. Similarly, users and providers may interact with the data management system 102 via the network 108 using the one or more user devices 110A-110N and the one or more partner devices 112A-112N.

The data management system 102 may receive information from, and transmit information to, the one or more user devices 110A-110N and the one or more partner devices 112A-112N. For example, the data management system 102 may transmit or receive wellness information, financial information, and/or information regarding sweat points associated with a particular user account from or to any of the one or more user devices 110A-110N or the one or more partner devices 112A-112N. In addition, the data management system 102 may transmit targeted messages to any of the one or more user devices 110A-110N, and may transmit or receive targeted messages from any of the one or more partner devices 112A-112N, or may otherwise transmit any other type of message to any of the one or more user devices 110A-110N or the one or more partner devices 112A-112N.

The one or more user devices 110A-110N may be embodied by any computing devices known in the art, and information received by the data management system 102 from the one or more user devices 110A-110N may be provided in various forms and via various methods. For example, the one or more user devices 110A-110N may include laptop computers, smartphones, netbooks, tablet computers, wearable devices, or the like, and the information may be provided through various sources corresponding to these various types of devices.

In some embodiments, a given one of the one or more user devices 110A-110N may execute an “app” designed to interact with the data management system 102 and/or other user devices or partner devices. Such apps are typically developed for execution on mobile devices, such as tablets or smartphones. For example, an app may be provided that executes on mobile device operating systems such as Apple Inc.'s iOS®, Google Inc.'s Android®, or Microsoft Inc.'s Windows 8®. These platforms typically provide frameworks that allow apps to communicate with one another and with particular hardware and software components of mobile devices. For example, the mobile operating systems named above each provide frameworks for interacting with location services circuitry, wired and wireless network interfaces, user contacts, and other applications in a manner that allows for improved interactions between apps while also preserving the privacy and security of individual users. In some embodiments, a mobile operating system may also provide for improved communication interfaces for interacting with external devices (e.g., wearable devices, home automation systems, and the like). Communication with hardware and software modules executing outside of the app is typically provided via application programming interfaces (APIs) provided by the mobile device operating system or by the maker of the external devices.

In the case of a user device 110, the data management system 102 may leverage the application framework offered by the mobile operating system to allow a corresponding user to designate which information is harvested by the app and which may then be provided to the data management system 102. In some embodiments, users may “opt in” to provide particular different types of wellness information or financial information in exchange for an increased benefit (e.g., a larger provision of sweat points). During installation or use of the app, the user may be provided with options for configuring privacy settings and with terms and conditions governing use of the wellness information or financial information harvested by the user device 110 and provided to the data management system 102. Once the user provides access to a particular feature of the user device 110, information derived from that feature may in some embodiments be provided to the data management system 102 to improve the quality of the user's interactions with the data management system 102 and/or with partner devices 112A-112N.

For example, a user may indicate a desire to provide information to the app from a financial services app installed on the user device 110. Providing this information to the data management system 102 may enable the data management system 102 to offer more effectively targeted messages to the user that are relevant to the particular location of the user (e.g., by providing promotions for merchants that the financial information indicates are of interest to the user), or may enable the harvesting of a more complete set of wellness information and, in turn, providing a greater number of sweat points to the user (e.g., by virtue of deducing when a user is located a gym based on financial transactions occurring at the gym, and rewarding that larger detected volume of gym attendance). It should be appreciated that while the app may enable configuration of privacy settings, the various mobile device operating systems may also provide the ability to regulate the types of information provided to the app associated with the data management system 102. For example, the user may decide to disable the ability of the app to access the financial services app, thus limiting the access of the user's location information to the data management system 102.

Additionally or alternatively, a given one of the one or more user devices 110A-110N may interact with the data management system 102 or any partner device 112A-112N via a web browser. As yet another example, a given one of the one or more user devices 110A-110N may include various hardware or firmware designed to interface with the data management system 102 or a partner device 112A-112N (e.g., as a purpose-built device offered for the primary purpose of communicating with other devices within the system architecture 100).

The partner devices 112A-112N may be any computing devices known in the art and operated by a merchant partner or a healthcare partner. Where a merchant partner operates a given partner device 112, the merchant partner device 112 may include a merchant point-of-sale device, a merchant e-commerce server, a merchant inventory system, a computing device accessing a web site designed to provide merchant access (e.g., a smartphone, PDA, or desktop computer configured to access a web page via a browser using a set of merchant account credentials), a standard telephone, or any combination thereof. The merchant partner device 112 may execute an application to interact with the data management system 102, and in some embodiments, to interact directly with one or more user devices 110A-110N. In this regard, the merchant partner device 112 may receive information from the data management system 102 (and/or directly from one or more of user devices 110A-110N)). This user information may comprise one or more of wellness information, financial information, and a total number of sweat points contained in the sweat point account associated with a user. In embodiments transmitting financial information to a merchant partner device 112, the financial information may be redacted to protect dissemination of PII, either at the discretion of corresponding users or of the data management system 102. In other such embodiments, the financial information may be anonymized and relayed via the data management system 102, so that the merchant has no knowledge of which user is associated with the received financial information.

The merchant partner device 112 may also transmit promotions from the merchant in various forms and via various methods. As one example, the merchant partner device 112 may identify, from wellness information regarding a user, products or services that are likely to be of interest to the user, and may generate promotions comprising one or more advertisements for one or more of those products or services, or related products or services (e.g., if the wellness information regarding a user indicates that the user runs frequently, the merchant partner device 112 may generate a running shoe promotion or a 5 k race promotion, or the like). The merchant partner device 112 may then transmit the promotion to the data management system 102 for distribution to the user device. In embodiments where the merchant partner device 112 receives financial information about a user that is anonymized, the merchant partner device 112 may still transmit a targeted message for delivery to the user, but the user to whom it will be delivered will remain unknown to the merchant and merchant partner device 112 unless that user proactively decides to contact the merchant in response to receiving the targeted message.

Where a healthcare company partner operates a given partner device 112, the healthcare partner device 112 may include a health plan generation server, a computing device accessing a web site designed to provide a representative with access (e.g., a smartphone, PDA, or desktop computer configured to access a web page via a browser using a set of user account credentials), or any combination thereof. The healthcare partner device 112 may execute an application to interact with the data management system 102, and in some embodiments, to interact directly with one or more user devices 110A-110N. In this regard, the healthcare partner device 112 may receive user information from the data management system 102 (and/or directly from one or more of user devices 110A-110N)). This user information may comprise one or more of wellness information, financial information, and a total number of sweat points contained in the sweat point account associated with a user. In embodiments transmitting financial information to a healthcare partner device 112, the financial information may be redacted to protect dissemination of PII, either at the discretion of corresponding users or of the data management system 102. In other such embodiments, the financial information may be anonymized and relayed via the data management system 102, so that the healthcare company or representative thereof has no knowledge of which user is associated with the received financial information.

The healthcare partner device 112 may also generate personalized health plans. As one example, the healthcare partner device 112 may generate a personalized health plan having personalized characteristics generated based on the received user information. The personalized characteristics may comprise a modified premium or deductible, or may include an incentive structure specifically tailored to a given user. The healthcare partner device 112 may then transmit the information regarding generated personalized health plans to the data management system 102 for distribution to the user device. In embodiments where the healthcare partner device 112 receives financial information about a user that is anonymized, the healthcare partner device 112 may still transmit the information regarding generated personalized health plans as a targeted message for delivery to the user, but the user to whom it will be delivered will remain unknown to the healthcare partner device 112 unless that user proactively decides to contact the healthcare company or a representative thereof in response to receiving the targeted message.

Having described an example system architecture 100 within which example embodiments are implemented, an example implementing apparatus 200 is described below for implementing example embodiments and features of the present disclosure.

### Example Implementing Apparatus

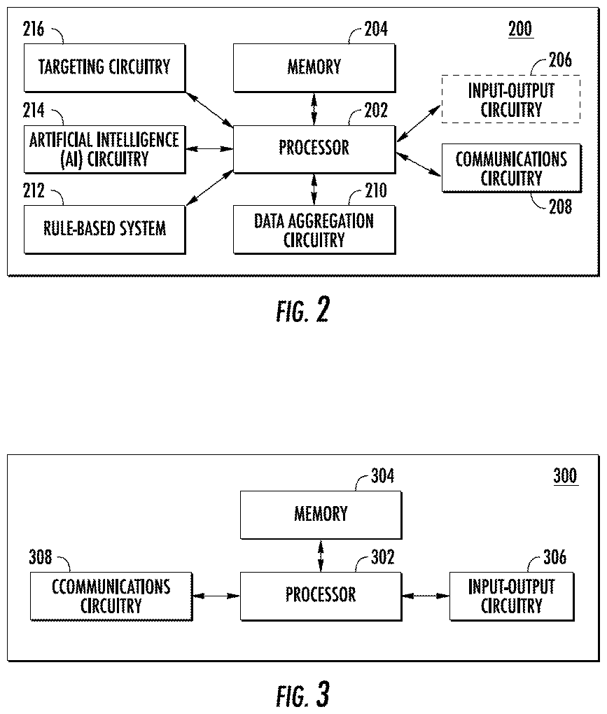

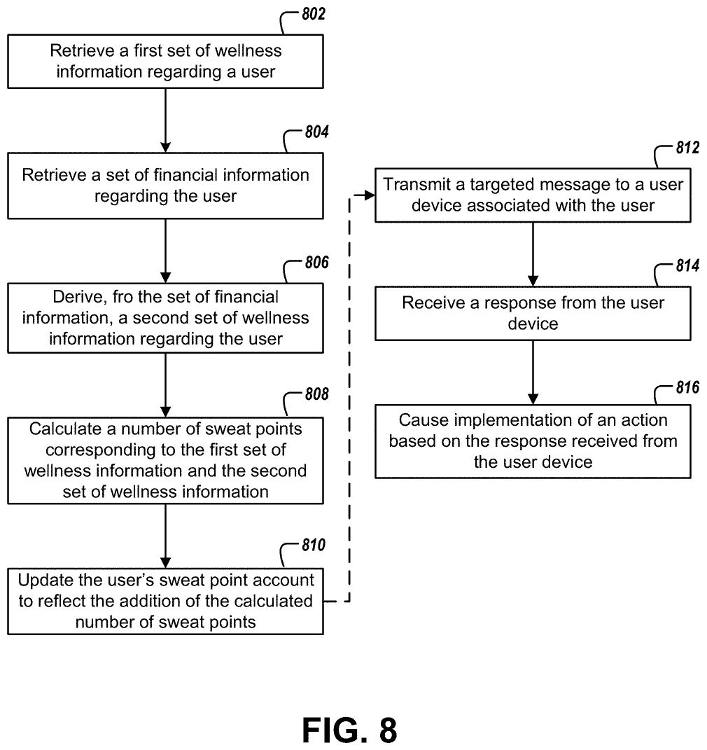

The data management system 102 described with reference to FIG. 1 may be embodied by one or more computing systems, such as the apparatus 200 shown in FIG. 2. As illustrated in FIG. 2, the apparatus 200 may include processor 202, memory 204, input-output circuitry 206, communications circuitry 208, data aggregation circuitry 210, a rule-based system 212, artificial intelligence (AI) circuitry 214, and targeting circuitry 216. The apparatus 200 may be configured to execute various operations described above with respect to FIG. 1 and below with respect to FIG. 8. In some embodiments, the apparatus 200 may further comprise a bus (not expressly shown) for passing information between any combinations of these various components.

The processor 202 may be embodied in a number of different ways and may, for example, include one or more processing devices configured to perform independently. Additionally or alternatively, the processor 202 may include one or more processors configured in tandem via a bus to enable independent execution of instructions, pipelining, and/or multithreading. The use of the term “processor” may be understood to include a single core processor, a multi-core processor, multiple processors internal to the apparatus, and/or remote or “cloud” processors.

In an example embodiment, the processor 202 may be configured to execute instructions stored in the memory 204 or otherwise accessible to the processor 202. Alternatively or additionally, the processor 202 may be configured to execute hard-coded functionality. As such, whether configured by hardware or software methods, or by a combination of hardware with software, the processor 202 represents an entity (e.g., physically embodied in circuitry) capable of performing operations according to embodiments of the present disclosure. As another example, when the processor 202 is embodied as an executor of software instructions, the instructions may specifically configure the processor 202 to perform the operations described herein when the instructions are executed.

The memory 204 may be non-transitory and may include, for example, one or more volatile and/or non-volatile memories. For example, the memory may be a computer readable storage medium storing a computer program product that, in turn, comprises computer-executable instructions (e.g., computer program instructions) that are executable by a processor. The memory 204 may additionally or alternatively be configured to store information, data, content, applications, instructions, or the like, for enabling the apparatus 200 to carry out various functions in accordance with example embodiments of the present disclosure. The memory 204 may, in this regard, host components such as one or more databases 106, referenced in FIG. 1 and described previously. Memory 204 may comprise any memory accessible by the processor 202, including internal memory or removable memory plugged into the apparatus 200, remote memory (e.g., cloud storage), and/or memory within the processor 202 itself.

In some embodiments, the apparatus 200 may include input-output circuitry 206 that may, in turn, be in communication with processor 202 to provide output to the user and, in some embodiments, to receive an indication of a user input such as a control signal provided by a user. The input-output circuitry 206 may comprise a user interface and may include a display that may include a web user interface, a mobile application, a client device, or any other suitable hardware or software. In some embodiments, the input-output circuitry 206 may also include a keyboard, a mouse, a joystick, a touch screen, touch areas, soft keys, a microphone, a speaker, or other input-output mechanisms. The processor 202 and/or input-output circuitry 206 (which may utilize the processor 202) may be configured to control one or more functions of one or more user interface elements through computer program instructions (e.g., software, firmware) stored on a memory (e.g., memory 204). Input-output circuitry 206 is optional and, in some embodiments, the apparatus 200 may not include input-output circuitry. For example, where the apparatus 200 does not interact directly with the user, the apparatus 200 may generate electronic content for display by one or more other devices with which one or more users directly interact and communications circuitry 208 of the apparatus 200 may be leveraged to transmit the generated electronic content to and from one or more of those devices.

Communications circuitry 208 comprises any device or circuitry embodied in either hardware or a combination of hardware and software that is configured to receive and/or transmit data from or to a network and/or any other device, circuitry, or module in communication with the apparatus 200. In this regard, the communications circuitry 208 may include, for example, a network interface for enabling communications with a wired or wireless communications network. For example, the communications circuitry 208 may include one or more network interface cards, antennae, buses, switches, routers, modems, and supporting hardware and/or software, or any other device suitable for enabling communications via a network. In some embodiments, the communication interface may include the circuitry for interacting with the antenna(s) to cause transmission of signals via the antenna(s) or to handle receipt of signals received via the antenna(s). These signals may be transmitted by the apparatus 200 using any of a number of wireless personal area network (PAN) technologies, such as Bluetooth® v1.0 through v3.0, Bluetooth Low Energy (BLE), infrared wireless (e.g., IrDA), ultra-wideband (UWB), induction wireless transmission, or any other suitable technologies. In addition, it should be understood that these signals may be transmitted using Wi-Fi®, Near Field Communications (NFC), Worldwide Interoperability for Microwave Access (WiMAX) or other proximity-based communications protocols.

The data aggregation circuitry 210 may be any device or circuitry embodied in either hardware or a combination of hardware and software that is configured to retrieve and/or derive wellness information and/or financial information regarding a user. The data aggregation circuitry 210 may include or utilize additional hardware components designed or configured to facilitate this functionality. These additional hardware components may, for instance, comprise processor 202 to perform various computing operations and a memory 204 for storage of wellness information, financial information, or any other data or electronic information received or generated by the data aggregation circuitry 210.

The rule-based system 212 may be any device or circuitry embodied in either hardware or a combination of hardware and software that is configured to calculate a number of sweat points corresponding to a received set of wellness information. To this end, the rule-based system 212 in some embodiments may comprise a system that implements manually-generated, crafted, or curated rules, although in in some embodiments, the rule-based system 212 may comprise a rule-based machine learning system in which the rules applied by the rule-based system 212 are modified (or at least the weights applied to the various rules are modified) based on determinations made by AI circuitry 214. The rule-based system 212 may include or utilize additional hardware components designed or configured to facilitate this functionality. These additional hardware components may, for instance, comprise processor 202 to perform various computing operations, a memory 204 for storage of a number of sweat points calculated by the rule-based system, and AI circuitry 214 for determining appropriate modifications to rules applied by the rule-based system 212 or to weights applied to various rules applied by the rule-based system 212.

The AI circuitry 214 may be any device or circuitry embodied in either hardware or a combination of hardware and software that is configured to generate a financial health recommendation and/or a wellness recommendation for a user based on wellness information. In some embodiments, the AI circuitry 214 is further configured to generate proposals for modification of the rules applied by a rule-based system 212 or to generate proposals for modifications of the weights applied to the rules applied by a rule-based system 212. The AI circuitry 214 may include or utilize additional hardware components designed or configured to facilitate this functionality. These additional hardware components may, for instance, comprise processor 202 to perform various computing operations and a memory 204 for storage of generated wellness recommendations or proposals for modifications of rules or weights to be applied to rules.

The targeting circuitry 216 may be any device or circuitry embodied in either hardware or a combination of hardware and software that is configured to generate a financial product recommendation based on wellness information, financial information, or information about user sweat points. The targeting circuitry 216 may include or utilize additional hardware components designed or configured to facilitate this functionality. These additional hardware components may, for instance, comprise processor 202 to perform various computing operations and a memory 204 for storage of the financial product recommendation and/or retrieval of wellness information, financial information, user sweat point information, and communications circuitry 208 for retrieval of wellness information, financial information, or user sweat point information from remote devices and for transmission of the financial product recommendation to a user device 110A-110N.

As illustrated in FIG. 3, an apparatus 300 is shown that represents an example user device or partner device (e.g., any of user devices 110A-110N or partner devices 112A-112N). The apparatus 300 includes processor 302, memory 304, input-output circuitry 306, and communications circuitry 308, and may optionally include additional components not described herein. As it relates to operations described in the present disclosure, the functioning of the processor 302, the memory 304, the input/output circuitry 306, and the communication circuitry 308 may be similar to the similarly named components described above with respect to FIG. 2, and for the sake of brevity, additional description of the mechanics of these components is omitted. Nevertheless, these device elements, operating together, provide the apparatus 300 with the functionality necessary to facilitate the communication of data (e.g., wellness information, financial information, information regarding sweat points, targeted messages and responsive communications, or the like) between the apparatus 300 and any other apparatus involved in the system architecture 100 (e.g., any of user devices 110A-110N, any of partner devices 112A-112N, and the data management system 102).

Although some of these components of apparatuses 200 and 300 are described by way of their functional capabilities, it should be understood that particular implementations of these apparatuses necessarily include the use of particular hardware to implement such functional capabilities. It should also be understood that certain of these components may include similar or common hardware. For example, two sets of circuitry may both leverage use of the same processor, network interface, communications circuitry, memory, or the like to perform their respective functions, such that duplicate hardware is not required for each set of circuitry (although duplicated hardware may be utilized in some embodiments). It should also be appreciated that, in some embodiments, one or more of these components described above may include a separate processor, specially configured field programmable gate array (FPGA), application specific interface circuit (ASIC), or cloud utility to perform its corresponding functions as described herein.

The use of the term “circuitry” with respect to components of apparatuses 200 and 300 therefore includes particular hardware configured to perform the functions associated with respective circuitry described herein. Of course, while the term “circuitry” should be understood broadly to include hardware, in some embodiments, circuitry may also include software for configuring the hardware. In some embodiments, other elements of apparatuses 200 and 300 may be bodily incorporated within a given circuitry to facilitate or supplement the functionality of particular circuitry. For example, any circuitry recited in connection with apparatus 200 may in some embodiments include a dedicated processor 202 to provide processing functionality, memory 204 to provide storage functionality, input-output circuitry 206 to provide user interface functionality, and/or communications circuitry 208 to provide network interface functionality as described above, but may also include additional circuitries not described in connection with FIG. 2 that provide other functionality.

In some embodiments, various components of the apparatuses 200 and 300 may be hosted remotely (e.g., by one or more cloud servers) and thus need not physically reside on the corresponding apparatus 200 or 300. Thus, some or all of the functionality described herein may be provided by third party circuitry. For example, a given apparatus 200 or 300 may access one or more third party circuitries via any sort of networked connection that facilitates transmission of data and electronic information between the apparatus 200 or 300 and the third party circuitries. In turn, that apparatus 200 or 300 may be in remote communication with one or more of the other components describe above as comprising the apparatus 200 or 300.

As will be appreciated, computer program instructions and/or other type of code may be loaded onto a computer, processor, or other programmable apparatus's circuitry to produce a machine, such that the computer, processor, or other programmable circuitry that executes the code on the machine creates the means for implementing various functions described herein.

As described above and as will be appreciated based on this disclosure, embodiments of the present disclosure may be configured as systems, apparatuses, methods, mobile devices, backend network devices, computer program products, other suitable devices, and combinations thereof. Accordingly, embodiments may comprise various means including entirely of hardware or any combination of software with hardware. Furthermore, embodiments may take the form of a computer program product on at least one non-transitory computer-readable storage medium having computer-readable program instructions (e.g., computer software) embodied in the storage medium. Any suitable computer-readable storage medium may be utilized including non-transitory hard disks, CD-ROMs, flash memory, optical storage devices, or magnetic storage devices.

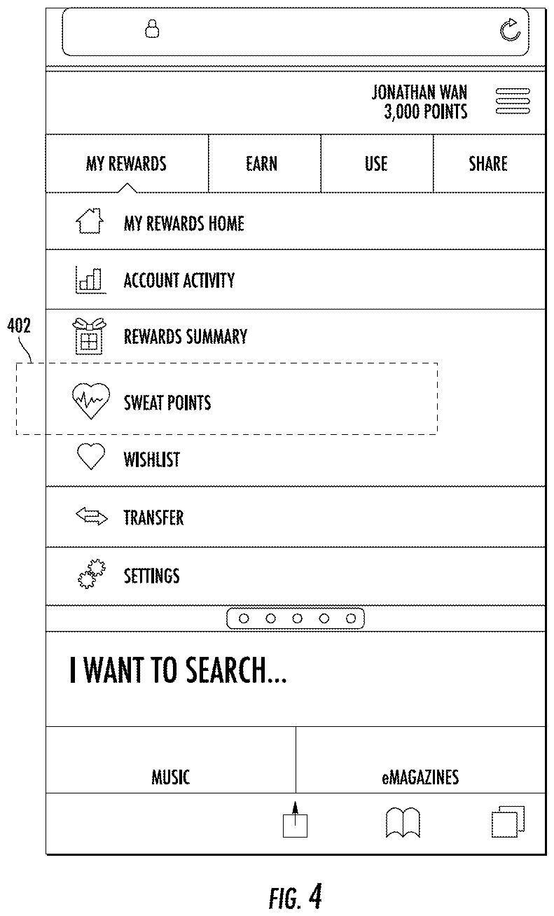

Having described specific components of example devices and circuitries involved in various embodiments contemplated herein, a series of example user interfaces are described below in connection with FIGS. 4-7 that illustrate some example implementations of embodiments of the present disclosure.

### Example User Interfaces

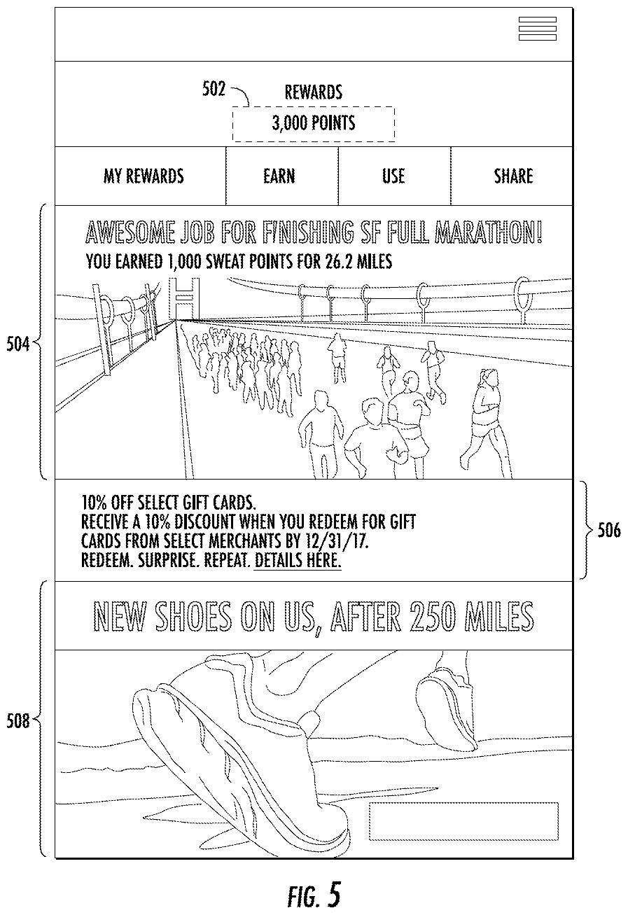

As noted above, FIGS. 4-7 illustrate some example user interfaces that may be utilized in connection with some example embodiments disclosed herein. Turning first to FIG. 4, a user interface is shown that may, for instance, be utilized by a financial institution's app that is installed on a smartphone or tablet device. The user interface may, in addition to the existing set of functionalities made available by the app, include a selectable icon 402 enabling a user to view information regarding a sweat point account associated with the user's account. Selection of the icon 402 may cause another user interface to appear, such as that shown in FIG. 5. In this additional user interface, information regarding a total number of sweat points associated with the user's account may be displayed (element 502). In addition, a targeted message 504 may be presented to the user that is generated by the data management system 102 to indicate a number of sweat points earned for an activity that the data management system 102 has determined that the user completed. In addition, one or more targeted messages 506 and 508 may be presented that represent promotions generated by merchant partners based on the wellness and possibly the financial information regarding the user that is gathered by the data management system 102. These targeted messages not only provide business value to a financial institution providing the data management system 102, but also provide psychic benefits and incentives for short- and medium-term activities that further incentivize the user to engage in increased physical activity.

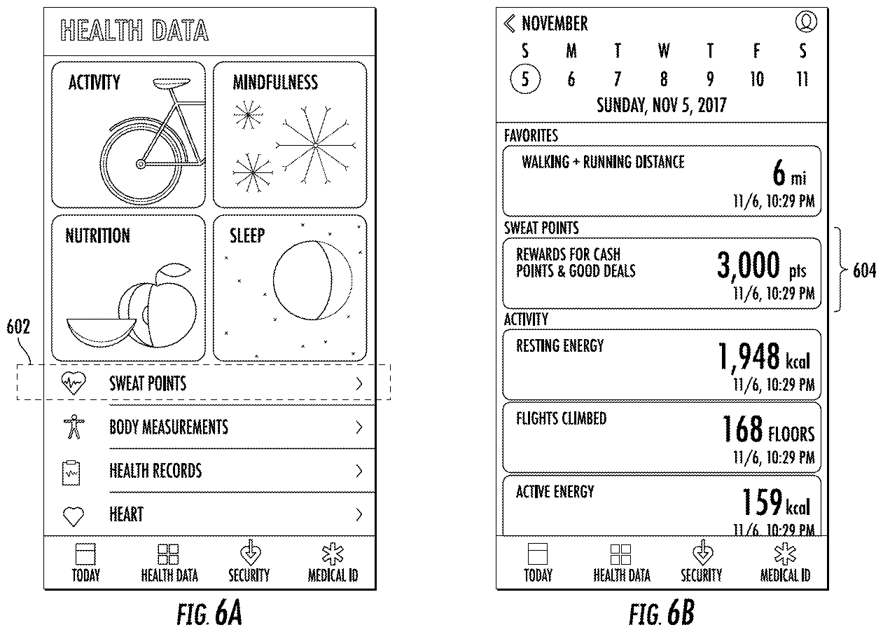

Turning next to FIGS. 6A and 6B, an integration between the sweat point functionality provided by the data management system 102 and a third party app is illustrated. As shown, a user interface that may be provided by a third party wellness management app can utilize an API call to add a widget or icon 602 that may provide information to a user regarding the user's sweat points. Similarly, a widget or icon 604 can be added to another user interface that already provides physical activity information in order to enable the user to visualize the points being accrued from the physical activity that the user is engaging in. As with the features illustrated in FIGS. 4 and 5, these additional components are designed to provide psychic benefits and incentives for short- and medium-term activities that further incentivize the user to engage in increased physical activity. Moreover, by facilitating the display of more attractive terms of various health plans based on a given user's wellness information, merchant partners are able to more effectively market their products and services to users, and the financial institution is able to provide a value-added service that may not be provided by competing institutions.

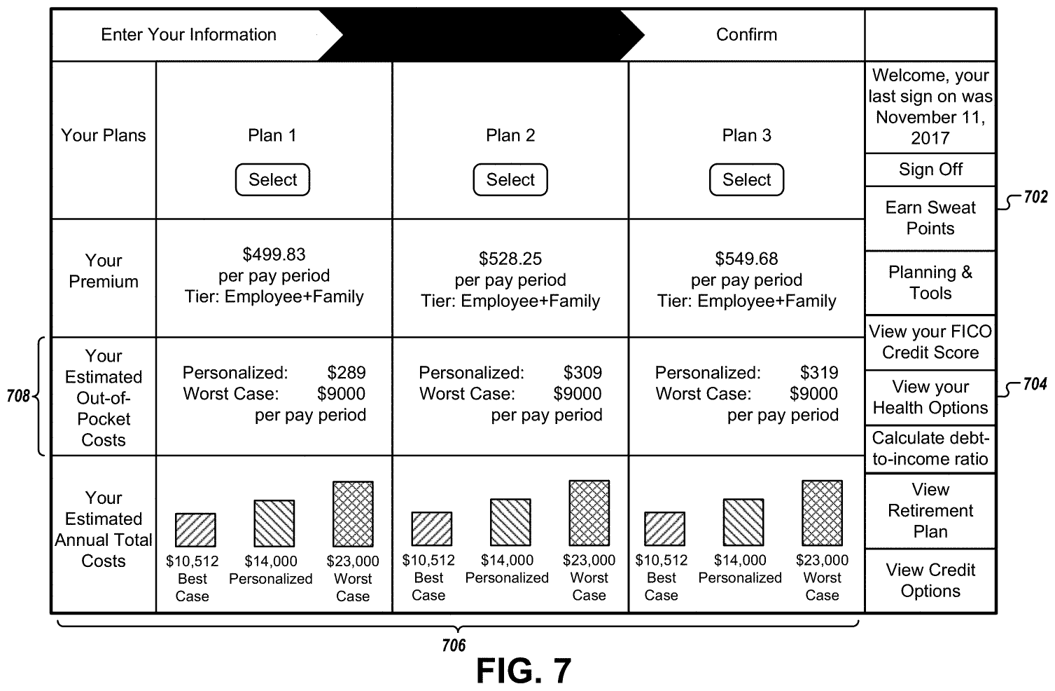

Turning finally to FIG. 7, a user interface is shown that may be provided by a financial institution on a web browser. This user interface may enable a variety of actions regarding the financial products provided by the financial institution (e.g., as shown in the bar along the right side of the graphical illustration in FIG. 7, the user may navigate to a retirement plan interface, or a credit score interface, or the like). In addition, however, the user interface may enable a user to navigate to an interface (not shown) to view more granular data regarding activities that may be enable the user to earn more sweat points. Similarly, an icon 704 may enable a user to view his or her health options. When selected, the user may be prompted to enter personal information, following which the user may be presented with the interface 706 illustrating a variety of health plans that are selectable by the user. In response to the receipt of targeted message from a healthcare partner device, these health plans may be updated to reflect personalized health plans that may be selected by a user, the personalization being based on the various wellness information collected about the user by the data management system 102 (as conveyed to the healthcare partner device). For instance, as shown in row 708, the various health plan options may be personalized to illustrate a revised estimated out-of-pocket costs that are likely to accrue to the user if the user were to select each of the displayed health plans. As with the features illustrated in FIGS. 4, 5, 6A, and 6B, these additional interface components are designed to provide psychic benefits and incentives for short- and medium-term activities that further incentivize the user to engage in increased physical activity. Moreover, by facilitating the display of more attractive terms of various health plans based on a given user's wellness information, healthcare partners are able to more effectively market their products and services to users, and the financial institution is able to provide a value-added service that may not be provided by competing institutions.

Having described a series of example user interfaces that may be implemented in connection with example embodiments described herein, some example operations for incentivizing physical activity are described below in connection with FIG. 8.

### Example Operations for Incentivizing Physical Activity

FIG. 8 illustrates a flowchart containing a series of operations for incentivizing physical activity based on a combination of wellness information and financial information. The operations illustrated in FIG. 8 may, for example, be performed by, with the assistance of, and/or under the control of an apparatus 200, as described above. In this regard, performance of the operations may invoke one or more of processor 202, memory 204, input/output circuitry 206, communications circuitry 208, data aggregation circuitry 210, rule-based system 212, AI circuitry 214, and/or targeting circuitry 216.

As shown in operation 802, the apparatus 200 includes means, such as memory 204, communications circuitry 208, data aggregation circuitry 210, or the like, for retrieving a first set of wellness information regarding the user. In some embodiments, retrieval of the first set of wellness information comprises generating, by for instance, the data aggregation circuitry 210, an electronic control signal requesting the first set of wellness information from a user device 110, and then transmitting, by the communications circuitry 208, the electronic control signal to a user device 110. In this regard, the user device 110 may comprise a wearable device operated by a user, or it may comprise a user device 110 that is, in turn, connected to a wearable device. In response to transmitting the electronic control signal, the apparatus 200 may thus receive the first set of wellness information from the user device 110.

In other embodiments, retrieval of the first set of wellness information comprises generating, by the data aggregation circuitry, an application programming interface (API) call structured to request the first set of wellness information from a third party application hosted by a user device 110 or a partner device 112. This third party application may, for instance be an application such as Strava, Apple Health or the like, that collects wellness information about a user from possibly many sources, or may be a proprietary application associated with a particular wearable device that allows for collection of the wellness data directly from the wearable device or in a proprietary format used by the wearable device. In any case, the communications circuitry subsequently transmits the API call to the user device 110 or the partner device 112, and in response to transmitting the API call, receives the first set of wellness information from the user device 110 or the partner device 112.

As shown in operation 804, the apparatus 200 include means, such as memory 204, communications circuitry 208, data aggregation circuitry 210, or the like, for retrieving a set of financial information regarding the user. In some embodiments, such as where the apparatus 200 comprises a component of a financial institution and the user device 110 is associated with one or more accounts provided by the financial institution, the set of financial information can be retrieved by the apparatus 200 from a memory accessible by the apparatus 200 (e.g., memory 204). In other embodiments, retrieval of the set of financial information comprises generating, by for instance, the data aggregation circuitry 210, an electronic control signal requesting the set of financial information from a third party (e.g., another financial institution), and then transmitting, by the communications circuitry 208, the electronic control signal to that third party, following which the apparatus 200 may receive the set of financial information from the third party. In some embodiments, the financial information is retrieved via a combination of these local and remote retrieval operations.

As shown in operation 806, the apparatus 200 include means, such as data aggregation circuitry 210 or the like, for deriving a second set of wellness information regarding the user from the set of financial information regarding the user. In some embodiments, this derivation may include parsing, by the data aggregation circuitry, the set of financial information to identify a subset of financial information indicative of physical activity, and then identifying, by the data aggregation circuitry, wellness information corresponding to each element of this subset of financial information. In such embodiments, the second set of wellness information may comprise the identified wellness information. To this end, it will be understood that the set of financial information may in some embodiments comprise transaction data from one or more credit or debit accounts associated with the user, and in such embodiments the subset of financial information indicative of physical activity may be the one or more transactions that are associated with merchants providing products or services related to wellness. To this end, the data management system 102 may, prior to performance of operation 806, predefine the set of merchants that are identified as providing products or services related to wellness. This predefinition process may be carried-out manually by a representative of the data management system 102, or may be crowd-sourced by providing sweat points to users in exchange for identification of merchants that provide products or services related to wellness, or may be crowd-sourced by merchants by requesting that merchants self-identify if they provide products or services related to wellness.

In other embodiments, location data corresponding to financial transactions can be used to identify the financial information indicative of physical activity. For instance, transaction data may have location metadata indicating where the transaction took place, and if that location is identifiable as being associated with physical activity (e.g., it is a gym, or a pool, the beach, etc.), then the data aggregation circuitry 210 may flag that element of financial information as being indicative of physical activity. As another example, even non-transaction financial information may be indicative of physical activity. For instance, if a person has a mortgage on a property located in a region known for physical activity, the financial information indicative of the mortgage may be indicative of physical activity.

As shown in operation 808, the apparatus 200 include means, such as rule-based system 212 or the like, for calculating a number of sweat points corresponding to the first set of wellness information and the second set of wellness information. In some embodiments, calculating the number of sweat points comprises providing the first set of wellness information and the second set of wellness information as inputs into the rule-based system 212, following which the rule-based system 212 calculates the number of sweat points based on a set of rules, each of which defines an allocation of a certain number of sweat points for a certain element, or combination of elements, of wellness information. To this end, each rule may have a predefined weight, such that the number of sweat points that the rule recommends allocating will be discounted by the rule's corresponding weight.

It will be understood that in certain embodiments, the set of rules may be modified by the AI circuitry 214. To this end, the AI circuitry 214 may evaluate a collection of user data across all users with which the data management system 102 interacts, and may determine that there are duplicate allocations of sweat points for certain elements of wellness information, or that other elements of wellness information are not afforded any sweat points under a current set of rules utilized by the rule-based system 212. In response, the AI circuitry 214 may generate a proposal for modifying one or more rules to prevent the duplicative allocation of sweat points for the certain elements of wellness information and may generate a proposal for adding one or more new rules that provide some default allocation of sweat points for the other elements of wellness information.

Similarly, it will be understood that in certain embodiments, the set of weights associated with the rules may be modified by the AI circuitry 214. To this end, the AI circuitry 214 may evaluate a collection of user data across all users with which the data management system 102 interacts, and may determine that certain allocations of sweat points for certain elements of wellness information produce an unusually large allocation of sweat points for the certain elements of wellness information relative to other elements of wellness information. In response, the AI circuitry 214 may generate a proposal for modifying one or more rules to change the weights applied to one or more rules utilized by the rule-based system 212.

Turning next to operation 810, the apparatus 200 include means, such as processor 202, memory 204, rule-based system 212, or the like, for updating the user's sweat point account to reflect the addition of the calculated number of sweat points. One mechanism for updating the user's sweat point account relies upon a system in which a database holds a field for each user identifying the number of sweat points owned by that user. In such a system, updating the user's sweat point account to reflect the addition of the calculated number of sweat points comprises incrementing a value stored in the database field corresponding to the user by the calculated number of sweat points, the value stored in the database field defining a total number of sweat points contained in a sweat point account associated with the user. This operation may be performed by the processor 202 in response to the calculation performed by the rule-based system 212 in operation 808, or it may be performed directly by the rule-based system 212 upon the calculation performed in operation 808. The database field may be stored in a database 106 of the data management system 102, which may be represented by a memory 204 of the apparatus 200.

As shown in operation 812, the apparatus 200 include means, such as targeting circuitry 216 or the like, for causing transmission of a targeted message to a user device 110. Prior to transmission of a targeted message, the targeted message must be retrieved or generated by the apparatus 200. To this end, the apparatus 200 may itself generate targeted messages comprising financial health recommendations, wellness recommendations, or financial product recommendations.

On the one hand, AI circuitry 214 may generate targeted messages comprising financial health recommendations or wellness recommendations. To this end, the AI circuitry may generate a financial health recommendation for the user based on the first set of wellness information and the set of financial information. Generation of the financial health recommendation may comprise providing the first set of wellness information and the set of financial information as inputs into a machine learning model, and in response, receiving the financial health recommendation for the user from the machine learning model. In some embodiments, the financial health recommendation may further be based on the second set of wellness information. The financial health recommendation may comprise a recommendation relating to the allocation of income amongst accounts, investment advice, budget advice with respect to categories of transactions relating to physical activity, or the like.

Similarly, the AI circuitry may generate a wellness recommendation for the user based on first set of wellness information and the second set of wellness information. Generation of the wellness recommendation may comprise providing first set of wellness information and the second set of wellness information as inputs into a machine learning model, and, in response, receiving the wellness recommendation for the user from the machine learning model. In some embodiments, the wellness recommendation may further be based on the set of financial information. The wellness recommendation may comprise a recommendation relating to the physical activities that the user may wish to participate in in the future. For instance, the wellness recommendation may comprise a recommendation to allocate more time to running and less time to yoga in view of the cost of yoga lessons in relation to the user's income stream. As another example, the wellness recommendation may comprise a recommendation to utilize a gym membership more frequently or to cancel it.

On the other hand, the targeting circuitry 216 may generate financial product recommendations based on based on one or more of (i) the first set of wellness information, (ii) the second set of wellness information, (iii) the set of financial information, and (iv) the total number of sweat points contained in the sweat point account associated with the user, a financial product recommendation. In this regard, a financial product recommendation may comprise an offer relating to a financial product or service that may be accepted in exchange for a particular number of sweat points. For instance, the offer may comprise a discount on a mortgage payment, an offer to exchange sweat points into other rewards currency, a cash-back offer, an offer of a reduction in premium of a loan, an offer of avoidance of overdraft fees, or any other offer relating to a financial product or service.

In some embodiments, the targeted message may be generated by a business partner. In such embodiments, the apparatus 200 may transmit, by communications circuitry 208, user information to a merchant partner device 112 or to a healthcare partner device 112. The user information may comprise one or more of (i) the first set of wellness information, (ii) the second set of wellness information, (iii) the set of financial information, or (iv) the total number of sweat points contained in the sweat point account associated with a user. In response to transmission of the user information, the apparatus 200 may receive, by the communications circuitry 208 and from the merchant partner device or the healthcare partner device, a targeted message. From a merchant partner device 112, the targeted message may comprise a promotion comprising an advertisement for a product or service, whereas from a healthcare partner device 112, the targeted message may comprise information describing a personalized health plan (e.g., a health plan having personalized characteristics).

In some embodiments, transmission of the targeted message may be triggered by at least one element of user information matching predefined thresholds or values associated with the targeted message (e.g., any one of (i) the value stored in the database field, (ii) the first set of wellness information, (iii) the second set of wellness information, or (iv) the set of financial information). In some embodiments, transmission may be triggered by two or more elements of this user information matching corresponding predefined values or thresholds. In still further embodiments, three, four, or more elements of user information must match corresponding predefined thresholds or values to prompt transmission of the targeted message. To this end, the predefined values or thresholds may be set by the party that generated the targeted message. In this regard, the data management system 102 may set the predefined values or thresholds for targeted messages comprising financial health recommendations, wellness recommendations, or financial product recommendations. In contrast, a merchant partner may set the predefined values or thresholds for targeted messages comprising promotions, and a healthcare partner may set the predefined values or thresholds for targeted messages comprising personalized health plans.

As shown in operation 814, the apparatus 200 include means, such as communications circuitry 208 or the like, for receiving a response from the user device 110.

Finally, as shown in optional operation 816, the apparatus 200 include means, such as processor 202, memory 204, input/output circuitry 206, communications circuitry 208, data aggregation circuitry 210, rule-based system 212, AI circuitry 214, targeting circuitry 216, or the like, for causing implementation of an action based on the response received from the user device 110. In some embodiments, the response comprises a declination of an offer contained in a targeted message, in which case the action may comprise transmitting, by communications circuitry 208, a message to a corresponding partner device 112 indicating that a targeted message generated by the associated business partner was not successful (metrics regarding conversion rate of various targeted messages often comprises actionable business intelligence that can be used to improve targeted messages in the future). However, where the response comprises an acceptance of an offer of a promotion or a personalized health plan, the action may still comprise transmission of a message to the corresponding partner device 112, but the message to the corresponding partner device 112 may instead indicate acceptance and any user-specific metadata necessary to enable the business partner to begin processing a transaction with the user.

It will be understood that the line connecting operation 810 to operations 812-816 is a dotted line, indicating that the transmission of targeted messaging (and follow-on activity) is one manner by which sweat points can be utilized, but not the only use of sweat points. In some embodiments, users may proactively seek to apply sweat points for discounts, rewards, rebates, and/or the like on purchases that they would already make. Moreover, while targeted message are transmitted in many embodiments described herein, they are not always transmitted each time a user's sweat point account is updated, so there is not necessarily a one-to-one correlation to the performance of operations 802-810 and the performance of operations 812-816. In this regard, operations 812-816 may in some embodiments be performed even when operations 802-810 are not (e.g., a targeted message is transmitted to a user even when the user's sweat point account is not updated).

As described above, example embodiments described herein provide tools for a financial institution to deploy a program that leverages wellness information in combination with financial information to generate a more complete and accurate representation of a user's wellness status that in turn can enable users to identify areas both in their physical activity and financial activity that could be better aligned to meet their wellness goals. Through the combination of wellness information and financial information, example embodiments further facilitate a broader array of uses for the combined set of wellness and financial information, such as the ability to provide improved targeting of advertisements or more closely tailored healthcare offerings. Finally, by providing new functionality and modes of user engagement that diverge from traditional offerings of financial institutions or wellness-focused entities, example embodiments described herein enable financial institutions to drive deeper and more meaningful relationships with existing customers and provide a new vehicle for securing new customer relationships.

FIG. 8 thus illustrates a flowchart describing the operation of apparatuses, methods, and computer program products according to example embodiments contemplated herein. It will be understood that each flowchart block, and combinations of flowchart blocks, may be implemented by various means, such as hardware, firmware, processor, circuitry, and/or other devices associated with execution of software including one or more computer program instructions. For example, one or more of the operations described above may be implemented by an apparatus executing computer program instructions. In this regard, the computer program instructions may be stored by a memory 204 of apparatus 200 and executed by a processor 202 of the apparatus 200. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture, the execution of which implements the functions specified in the flowchart blocks. The computer program instructions may also be loaded onto a computer or other programmable apparatus to cause a series of operations to be performed on the computer or other programmable apparatus to produce a computer-implemented process such that the instructions executed on the computer or other programmable apparatus provide operations for implementing the functions specified in the flowchart blocks.

The flowchart blocks support combinations of means for performing the specified functions and combinations of operations for performing the specified functions. It will be understood that one or more blocks of the flowcharts, and combinations of blocks in the flowcharts, can be implemented by special purpose hardware-based computer systems which perform the specified functions, or combinations of special purpose hardware with computer instructions.

### CONCLUSION

While various embodiments in accordance with the principles disclosed herein have been shown and described above, modifications thereof may be made by one skilled in the art without departing from the teachings of the disclosure. The embodiments described herein are representative only and are not intended to be limiting. Many variations, combinations, and modifications are possible and are within the scope of the disclosure. Alternative embodiments that result from combining, integrating, and/or omitting features of the embodiment(s) are also within the scope of the disclosure. Accordingly, the scope of protection is not limited by the description set out above, but is defined by the claims which follow, that scope including all equivalents of the subject matter of the claims. Each and every claim is incorporated as further disclosure into the specification and the claims are embodiment(s) of the present disclosure. Furthermore, any advantages and features described above may relate to specific embodiments, but shall not limit the application of such issued claims to processes and structures accomplishing any or all of the above advantages or having any or all of the above features.

In addition, the section headings used herein are provided for consistency with the suggestions under 37 C.F.R. 1.77 or to otherwise provide organizational cues. These headings shall not limit or characterize the disclosure set out in any claims that may issue from this disclosure. For instance, a description of a technology in the “Background” is not to be construed as an admission that certain technology is prior art to any disclosure in this disclosure. Neither is the “Summary” to be considered as a limiting characterization of the disclosure set forth in issued claims. Furthermore, any reference in this disclosure to “disclosure” or “embodiment” in the singular should not be used to argue that there is only a single point of novelty in this disclosure. Multiple embodiments of the present disclosure may be set forth according to the limitations of the multiple claims issuing from this disclosure, and such claims accordingly define the disclosure, and their equivalents, that are protected thereby. In all instances, the scope of the claims shall be considered on their own merits in light of this disclosure, but should not be constrained by the headings set forth herein.

Also, techniques, systems, subsystems, and methods described and illustrated in the various embodiments as discrete or separate may be combined or integrated with other systems, modules, techniques, or methods without departing from the scope of the present disclosure. Other devices or components shown or discussed as coupled to, or in communication with, each other may be indirectly coupled through some intermediate device or component, whether electrically, mechanically, or otherwise. Other examples of changes, substitutions, and alterations are ascertainable by one skilled in the art and could be made without departing from the scope disclosed herein.

Many modifications and other embodiments of the disclosure set forth herein will come to mind to one skilled in the art to which these embodiments pertain having the benefit of teachings presented in the foregoing descriptions and the associated figures. Although the figures only show certain components of the apparatus and systems described herein, it is understood that various other components may be used in conjunction with the supply management system. Therefore, it is to be understood that the disclosure is not to be limited to the specific embodiments disclosed and that modifications and other embodiments are intended to be included within the scope of the appended claims. For example, the various elements or components may be combined, rearranged, or integrated in another system or certain features may be omitted or not implemented. Moreover, the steps in any method described above may not necessarily occur in the order depicted in the accompanying figures, and in some cases one or more of the steps depicted may occur substantially simultaneously, or additional steps may be involved. Although specific terms are employed herein, they are used in a generic and descriptive sense only and not for purposes of limitation.

1. A computer-implemented method for incentivizing physical activity based on a combination of wellness information and financial information, the computer-implemented method comprising:
retrieving, by data aggregation circuitry, a first set of wellness information regarding a user from a first computing device;
retrieving, by the data aggregation circuitry, a set of financial information regarding the user, at least a portion of the set of financial information retrieved from a second computing device separate from the first computing device;
deriving, by the data aggregation circuitry, a second set of wellness information regarding the user from the set of financial information regarding the user;
calculating, by a rule-based system, a number of sweat points corresponding to the first set of wellness information and the second set of wellness information;
incrementing a value stored in a database field by the calculated number of sweat points, the value stored in the database field defining a total number of sweat points contained in a sweat point account associated with the user;
generating, by artificial intelligence (AI) circuitry, a wellness recommendation for the user based on the first set of wellness information and the second set of wellness information; and
causing, by targeting circuitry, transmission of a targeted message to the user based on at least one of (i) the value stored in the database field, (ii) the first set of wellness information, (iii) the second set of wellness information, or (iv) the set of financial information, wherein the targeted message includes the wellness recommendation.

2. The computer-implemented method of claim 1, wherein causing transmission of the targeted message to the user comprises:
causing, by targeting circuitry, transmission of the targeted message to the user based on two or more of (i) the value stored in the database field, (ii) the first set of wellness information, the second set of wellness information, or (iv) the set of financial information.

3. The computer-implemented method of claim 1, wherein retrieving the first set of wellness information regarding the user comprises:
transmitting, by communications circuitry, an electronic control signal requesting the first set of wellness information from a wearable device associated with the user, wherein the first computing device comprises the wearable device; and
in response to transmitting the electronic control signal, receiving the first set of wellness information from the wearable device.

4. The computer-implemented method of claim 1, wherein retrieving the first set of wellness information regarding the user comprises:
generating, by the data aggregation circuitry, an application programming interface (API) call structured to request the first set of wellness information from a third party application hosted by a user device or a partner device, wherein the second computing device comprises the user device or the partner device;
transmitting, by communications circuitry, the API call to the user device or the partner device; and
in response to transmitting the API call, receiving the first set of wellness information from the user device or the partner device.

5. The computer-implemented method of claim 1, wherein retrieving the set of financial information regarding the user comprises:
retrieving the set of financial information by the data aggregation circuitry and from a memory.

6. The computer-implemented method of claim 1, wherein deriving the second set of wellness information regarding the user from the set of financial information regarding the user comprises:
parsing, by the data aggregation circuitry, the set of financial information to identify a subset of financial information indicative of physical activity; and
identifying, by the data aggregation circuitry, wellness information corresponding to each element of the subset of financial information,
wherein the second set of wellness information comprises the identified wellness information.

7. The computer-implemented method of claim 6,
wherein the set of financial information comprises transaction data from one or more credit or debit accounts associated with the user, and
wherein the subset of financial information indicative of physical activity comprises one or more transactions associated with merchants from a predefined set of merchants that are identified as providing products or services related to wellness.

8. The computer-implemented method of claim 1, further comprising:
generating, by the AI circuitry, a financial health recommendation for the user based on the first set of wellness information and the set of financial information,
wherein the targeted message comprises the financial health recommendation.

9. The computer-implemented method of claim 8, wherein generating the financial health recommendation for the user comprises:
providing the first set of wellness information and the set of financial information as inputs into a machine learning model; and
in response to providing the wellness information and the set of financial information, receiving the financial health recommendation for the user from the machine learning model.

10. (canceled)

11. The computer-implemented method of claim 1, wherein the AI circuitry comprises a machine learning model, and wherein generating the wellness recommendation comprises:
providing the first set of wellness information and the second set of wellness information as inputs into the machine learning model; and
in response to providing the first set of wellness information and the second set of wellness information to the machine learning model, receiving the wellness recommendation for the user from the machine learning model.

12. The computer-implemented method of claim 1, wherein calculating the number of sweat points that corresponds to the first set of wellness information and the second set of wellness information comprises:
providing the first set of wellness information and the second set of wellness information as inputs into the rule-based system; and
calculating, by the rule-based system and based on a set of rules governing the rule-based system and having predefined point allocations for predefined activities, a number of points corresponding to the first set of wellness information and the second set of wellness information.

13. The computer-implemented method of claim 12, further comprising:
modifying, by the AI circuitry and based on the first set of wellness information or the second set of wellness information, the set of rules.

14. The computer-implemented method of claim 12, further comprising:
modifying, by the AI circuitry and based on the first set of wellness information and the second set of wellness information, a set of weights associated with the set of rules.

15. The computer-implemented method of claim 1, wherein causing transmission of the targeted message to the user comprises:
transmitting, by communications circuitry and to a merchant partner device, user information comprising one or more of (i) the first set of wellness information, (ii) the second set of wellness information, (iii) the set of financial information, and (iv) the total number of sweat points contained in the sweat point account associated with the user; and
receiving, by the communications circuitry and from the merchant partner device, a promotion comprising an advertisement for a product or service,
wherein the targeted message comprises the promotion.

16. The computer-implemented method of claim 1, wherein causing transmission of the targeted message to the user comprises:
transmitting, by communications circuitry and to a healthcare partner device, user information comprising one or more of (i) the first set of wellness information, (ii) the second set of wellness information, (iii) the set of financial information, and (iv) the total number of sweat points contained in the sweat point account associated with the user; and
receiving, by the communications circuitry and from the healthcare partner device, information describing a personalized health plan from the healthcare partner device, the personalized health plan comprising a health plan having personalized characteristics,
wherein the targeted message comprises the information describing the personalized health plan.

17. The computer-implemented method of claim 1, further comprising:
generating, by targeting circuitry and based on one or more of (i) the first set of wellness information, (ii) the second set of wellness information, (iii) the set of financial information, and the total number of sweat points contained in the sweat point account associated with the user, a financial product recommendation, the financial product recommendation including an offer relating to a financial product or service that may be accepted in exchange for a particular number of sweat points,
wherein the targeted message comprises the financial product recommendation.

18. The computer-implemented method of claim 1, further comprising:
receiving, by communications circuitry, a response to the targeted message; and causing implementation of an action based on the response.

19. An apparatus for incentivizing physical activity based on a combination of wellness information and financial information, the apparatus comprising circuitry components configured to:
retrieve a first set of wellness information regarding a user from a first computing device;
retrieve a set of financial information regarding the user, at least a portion of the set of financial information retrieved from a second computing device separate from the first computing device;
derive a second set of wellness information regarding the user from the set of financial information regarding the user;
calculate, by a rule-based system, a number of sweat points corresponding to the first set of wellness information and the second set of wellness information;
increment a value stored in a database field by the calculated number of sweat points, the value stored in the database field defining a total number of sweat points contained in a sweat point account associated with the user;
generate a wellness recommendation for the user based on the first set of wellness information and the second set of wellness information; and
cause transmission of a targeted message to the user based on at least one of (i) the value stored in the database field, (ii) the first set of wellness information, (iii) the second set of wellness information, or (iv) the set of financial information, wherein the targeted message includes the wellness recommendation.

20. A computer program product for incentivizing physical activity based on a combination of wellness information and financial information, the computer program product comprising at least one non-transitory computer-readable medium storing computer-executable instructions that, when executed, cause an apparatus to:
retrieve a first set of wellness information regarding a user from a first computing device;
retrieve a set of financial information regarding the user, at least a portion of the set of financial information retrieved from a second computing device separate from the first computing device;
derive a second set of wellness information regarding the user from the set of financial information regarding the user;
calculate, by a rule-based system, a number of sweat points corresponding to the first set of wellness information and the second set of wellness information;
increment a value stored in a database field by the calculated number of sweat points, the value stored in the database field defining a total number of sweat points contained in a sweat point account associated with the user;
generate a wellness recommendation for the user based on the first set of wellness information and the second set of wellness information; and
cause transmission of a targeted message to the user based on at least one of (i) the value stored in the database field, (ii) the first set of wellness information, (iii) the second set of wellness information, or (iv) the set of financial information, wherein the targeted message includes the wellness recommendation.

21. The computer-implemented method of claim 1, wherein the financial information is retrieved from a financial services application installed on the second device.
